(19) United States
(12) Patent Application Publication
(10) Pub. No.: US 2024/0388928 A1
(43) Pub. Date: Nov. 21, 2024

(54) MEDIUM ACCESS CONTROL IN PACKET NETWORKS

(71) Applicant: Analog Devices International Unlimited Company, Limerick (IE)

(72) Inventors: Seamus Anthony Ryan, Nenagh (IE); Harsh Bolia, Bangalore (IN); R Advaith Ananth Krishnan, Bangalore (IN); John Cullinane, Kilmallock (IE)

(21) Appl. No.: 18/351,234

(22) Filed: Jul. 12, 2023

(30) Foreign Application Priority Data
May 16, 2023 (IN) 202341034296

(51) Int. Cl. H04W 24/02; H04W 74/08

(52) U.S. Cl. CPC H04W 24/02; H04W 74/0816

(57) ABSTRACT

Reading, by a controller of the network, a first PLCA ID of each of N follower nodes of the network. First remapping, by the controller, each read first PLCA ID to one of N+1 unique remapped PLCA IDs. One PLCA ID of the N+1 unique remapped PLCA IDs is reserved for one of the follower nodes requesting a subsequent re-mapping of PLCA IDs. The N+1 unique remapped PLCA IDs start at a lowest PLCA ID and proceed through consecutive PLCA IDs.

### CROSS-REFERENCE TO RELATED APPLICATIONS

This application claims the benefit of Indian Provisional Application No. 2023 41034296, titled “Physical Layer Collision Avoidance (PLCA) Identifier Management in a 10BASE-T1S Network,” filed May 16, 2023, the disclosure of which is incorporated herein by reference in its entirety.

### FIELD OF THE DISCLOSURE

This disclosure relates to networking, generally. More specifically, the disclosure describes technology for medium access control, using Physical Layer Collision Avoidance (PLCA) in a 10BASE-T1S network as an example.

### BACKGROUND

10BASE-T1S is a type of Ethernet communication standard in which a network can operate at 10 megabits per second (Mbps) over a single twisted pair of wires. The standard is an extension of the Institute of Electrical and Electronics Engineers (IEEE) 802.3 standards for Ethernet networks. 10BASE-T1S offers a range of up to 15m—e.g., finding use in automotive networks to connect and control low speed sensors and actuators. Both star and bus topologies are supported in 10BASE-T1S networks.

Since the twisted pair is a shared physical layer/medium across network nodes, contention for access to the medium (e.g., collisions) are likely to occur. Such collisions can be handled, in part, through the use of a medium access control (MAC) protocol such as carrier-sense multiple access/collision avoidance (CSMA/CD). In CSMA/CD network nodes listen for a carrier signal on the twisted pair and perform collision detection to avoid simultaneous transmission. However, CSMA/CD involves substantial overhead, reducing performance in the network.

The PLCA protocol was introduced to address some of the disadvantages of CSMA/CD. PLCA is designed to manage contention for the medium through use of a type of slot-based Time Division Multiple Access (TDMA). In PLCA, a single coordinating node (known as the “coordinator node,” “controller node,” or “node 0”) regularly transmits a marker signal (a “beacon”). The other nodes in the bus are “follower nodes.” After each beacon, each follower node is granted a transmit opportunity (TO). Each node monitors for beacons and its ensuing TO. If it has data to send, a node starts transmission only during its TO. Unlike with most TDMA techniques, a node can surrender its TO near the beginning of the TO if the node does not have data to transmit—e.g., by not transmitting (or not committing to transmit) during a TO timer slot.

### SUMMARY OF THE DISCLOSURE

In some aspects, the technology described includes computer-implemented methods, systems, and computer program products for medium access control in packet networks. In some examples, the technology includes reading, by a controller of the network, a first PLCA ID of each of N follower nodes of the network. The controller first remaps each read first PLCA ID to one of N+1 unique remapped PLCA IDs. One PLCA ID of the N+1 unique remapped PLCA IDs is reserved for one of the follower nodes requesting a subsequent re-mapping of PLCA IDs. The N+1 unique remapped PLCA IDs start at a lowest PLCA ID and proceed through consecutive PLCA IDs.

In some examples remapping includes setting the reserved PLCA ID to N+1, and setting a node count to N+2. In some such examples, the controller further writes, to each of the N follower nodes, the remapped PLCA ID corresponding to the node. In some such examples, the controller requests, from each of the N follower nodes, the PLCA ID corresponding to the node. The controller then reads, from each follower node responding to the request, a PLCA ID corresponding to the node. The controller then determines whether the second read PLCA ID for each node matches a first written PLCA ID for the corresponding node.

In some examples, a follower node detects a condition implicating PLCA IDs. The follower node then requests, in a transmission opportunity (TO) of the reserved PLCA ID, from the controller node, and in response to the detecting, to remap PLCA IDs among the nodes. The controller then performs one of the following in response to the request to subsequent remap: [1] writing, by the controller to the requesting node, the first remapped PLCA ID corresponding to the requesting node; and [2] second remapping, by the controller, each read PLCA ID to one of N+1 unique PLCA IDs, wherein one PLCA ID of the N+1 unique PLCA IDs is reserved for one or more nodes requesting a re-mapping of PLCA IDs among the nodes; and writing, by the controller to each follower node, the second remapped PLCA ID corresponding to the node.

In some examples, the controller node reads signal activity indicative of a collision between a plurality of follower nodes contending for use of the reserved PLCA ID. In such examples, the controller performs one of the following in response to the reading: [1] writing, by the controller to each colliding follower node, the first remapped PLCA ID corresponding to the colliding follower node; and [2] second remapping, by the controller, each read PLCA ID to one of N+1 unique PLCA IDs, wherein one PLCA ID of the N+1 unique PLCA IDs is reserved for one or more nodes requesting a re-mapping of PLCA IDs among the nodes; and writing, by the controller to each colliding follower node, the second remapped PLCA ID corresponding to the node.

### BRIEF DESCRIPTION OF THE DRAWINGS

The present invention will now be described in more detail with reference to the accompanying drawings, which are not intended to be limiting.

FIG. 1 is a block diagram of an illustrative two-wire communication system, in accordance with examples of the technology disclosed herein.

FIG. 2 provides a high-level description used in a continuing example for the following figures.

FIG. 3 illustrates a customer module production phase for the continuing example, in accordance with examples of the technology disclosed herein.

FIG. 4 illustrates methods of medium access control, in accordance with examples of the technology disclosed herein.

FIG. 5 illustrates a network commissioning phase for the continuing example, in accordance with examples of the technology disclosed herein.

FIG. 6 illustrates methods of medium access control, in accordance with examples of the technology disclosed herein.

FIG. 7 illustrates a runtime initialization phase for the continuing example, in accordance with examples of the technology disclosed herein.

FIG. 8 illustrates methods of medium access control, in accordance with examples of the technology disclosed herein.

FIG. 9 illustrates methods of medium access control, in accordance with examples of the technology disclosed herein.

FIG. 10 illustrates a runtime monitoring phase for the continuing example, in accordance with examples of the technology disclosed herein.

FIG. 11 illustrates a state diagram for medium access control operations at a controller, in accordance with examples of the technology disclosed herein.

FIG. 12 illustrates a state diagram for medium access control operations at a controller, in accordance with examples of the technology disclosed herein.

FIG. 13 schematically illustrates a device that may serve as a node (e.g., a controller node, a follower node) in the system, in accordance with examples of the technology disclosed herein.

### DETAILED DESCRIPTION

In the following detailed description, reference is made to the accompanying drawings which form a part hereof wherein like numerals designate like parts throughout, and in which is shown by way of illustration examples that may be practiced. It is to be understood that other examples may be utilized, and structural or logical changes may be made, without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described example. Various additional operations may be performed and/or described operations may be omitted in additional examples.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

Various components may be referred to or illustrated herein in the singular (e.g., a “processor,” a “peripheral device,” etc.), but this is simply for ease of discussion, and any element referred to in the singular may include multiple such elements in accordance with the teachings herein.

The description uses the phrases “in an example” or “in examples,” which may each refer to one or more of the same or different examples. Furthermore, the terms “comprising,” “including,” “having,” and the like, as used with respect to examples of the present disclosure, are synonymous. As used herein, the term “circuitry” may refer to, be part of, or include an application-specific integrated circuit (ASIC), an electronic circuit, and optical circuit, a processor (shared, dedicated, or group), and/or memory (shared, dedicated, or group) that execute one or more software or firmware programs, a combinational logic circuit, and/or other suitable hardware that provide the described functionality.

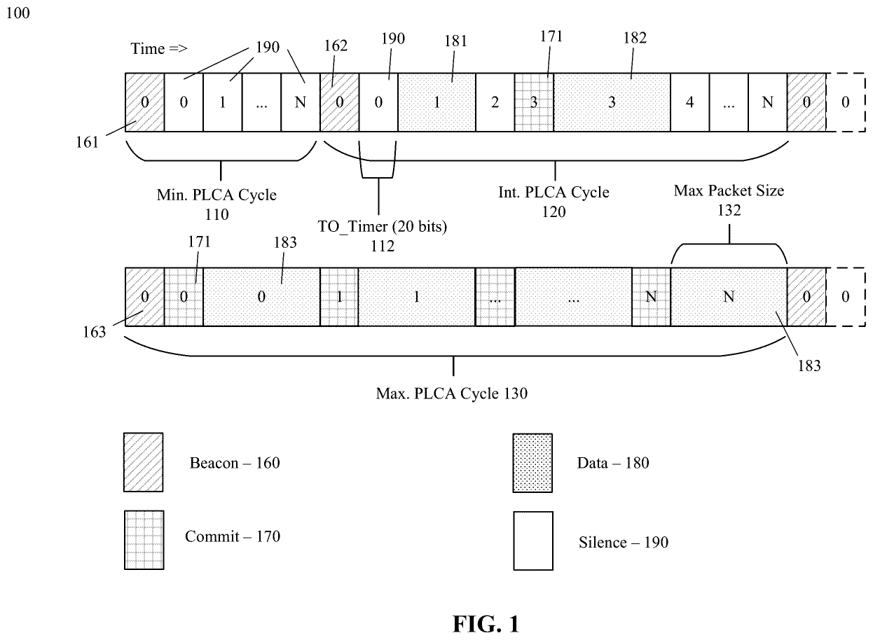

FIG. 1 illustrates example PLCA cycles 100 for a notional network. The example PLCA cycles 100 of FIG. 1 include a PLCA cycle of minimum length 110, a PLCA cycle of intermediate/typical length 120, and a PLCA cycle of maximum length 130. In particular, FIG. 1 illustrates PLCA cycles 100 for a network that includes a controller (node 0) and N follower nodes. Each slot in each cycle is one of: [1] a beacon 160 from the controller; [2] a commit signal 170 from a node (either the controller or a follower) at the beginning of the TO allocated to the node—an allowed, but not necessary, signal indicating that the node that has been allocated the TO will be transmitting data; [3] data 180; or [4] no signal/silence 190.

Each cycle (slots “beacon,” 0, 1, . . . N) begins with a beacon from the controller. In the minimum PLCA cycle 110, after the beacon 161, each node (having no data to transmit) remains in silence 190 for the length of the TO timeout period, e.g., twenty bits shown as TO_Timer 112. In the example typical PLCA cycle 120, after beacon the 162, the controller remains in silence 190 and times out, node 1 transmits data 181, node 2 remains in silence 191 and times out, node 3 first transmits a commit signal 171 indicating that it will not abandon its TO and then transmits data 182. In the example maximum PLCA cycle 130, after the beacon 163 from the controller, each of the controller and each other node transmits both a commit signal 171 and the maximum packet 132 of data, e.g., data 183.

Note that the PLCA cycle length for any given combination of commit signals 171 and data 182 increases as the highest node identifier (ID) in the network increases. PLCA node IDs are assigned on a per module basis to ensure each module used within a particular network (e.g., a car network) is unique. Up to 255 unique modules may be used within such a network. This can result in a network having a number X less than 255 follower nodes, but a highest node ID of N>X and up to 255. Having a highest PLCA ID greater than the number of nodes in the network reduces bandwidth and increases latency due to wastage in unused TOs that must each time out before the next TO, which reduces network performance. In addition, having any duplicate PLCA IDs can cause collision in the network, also reducing performance.

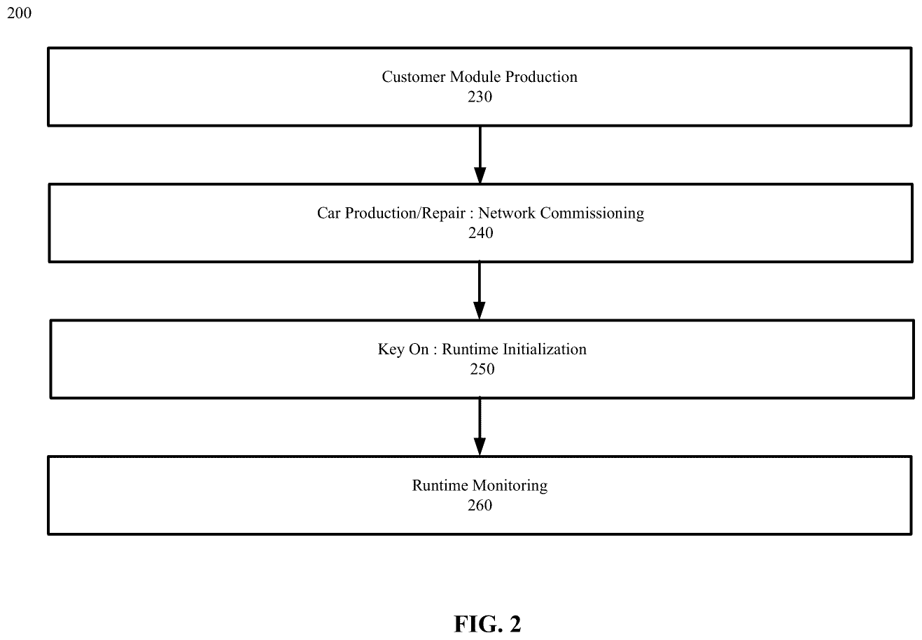

Referring to FIG. 2, and continuing to refer to FIG. 1 for context, a four-stage model 200 of the process of building and operating a 10BASE-T1S in a car is shown, in accordance with examples of the technology disclosed herein. FIG. 2 provides a high-level description used in a continuing example for the following figures. In a customer module production phase 230, a test controller can be used to program each follower node including assigning a node ID (also referred to as a “module ID”). In the network commissioning phase 240, used both during car production and during repair that implicates the particular module, the controller installed in the car discovers each of the modes in the network. An example runtime initialization phase 250 is when someone turns the key on in a car that includes a commissioned network. During runtime, the network is in the runtime monitoring phase 260, each node monitors for and responds to unexpected events and media access-related interrupts in the initialized network.

The technology disclosed herein can reduce the wastage in unused TOs in conventional PCLA where a highest PLCA ID is greater than the number of nodes in the network, and can allow for mitigating the effect of duplicate node IDs.

In examples of the technology disclosed herein, during network commissioning 240, PLCA IDs of all follower nodes are read by the controller and a re-mapping table with the current and the new remapped PLCA IDs is created by the controller to minimize the highest PLCA ID utilized on the network segment while also eliminating duplication. During runtime initialization 250, the controller gives each new remapped PLCA ID to all follower nodes and configures the node count to one more than the number of follower nodes—this is done for runtime remap requests as explained below. During the runtime monitoring phase 260, if a follower node faces an unexpected reset event, the follower node switches the PLCA ID to the unassigned TO slot (e.g., at the end of the PLCA cycle) and requests for the remapped node ID. The controller node provides the remapped ID once again. This additional PLCA slot helps the follower node in avoiding a collision with any other node during runtime and helps in maintaining the performance of the link.

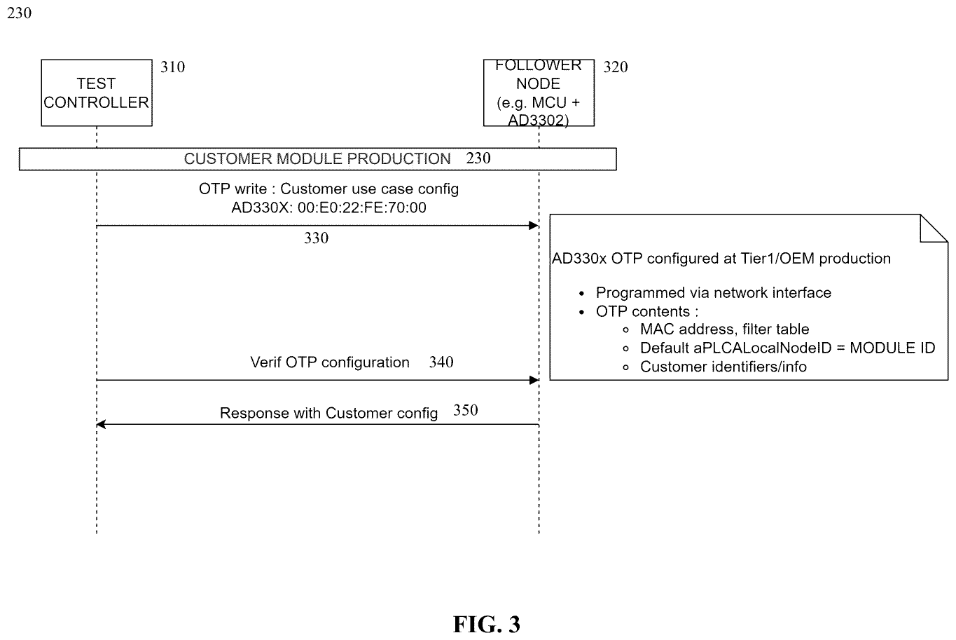

Referring to FIG. 3, and continuing to refer to prior figures for context, a customer module production phase 230 for a continuing example is illustrated, in accordance with examples of the technology disclosed herein. In the illustrated customer module production phase 230, a test controller 310 is in communication with a follower node 320. The test controller 310 performs a one-time programmable (OTP) write 350 of a customer use case configuration to the follower node 320. The configuration includes a default PLCA module ID “aPLCALocalNodeID” along with a MAC address and other parameters. The module ID for a follower can be from 1-255, with module ID “0” typically reserved for the controller 310. The test controller 310 then requests 340 verification of the written configuration via the 10BASE-T1S network interface from the follower node 320, and the follower node 320 responds 350 with its current configuration. These operations are repeated for each follower node 320 module.

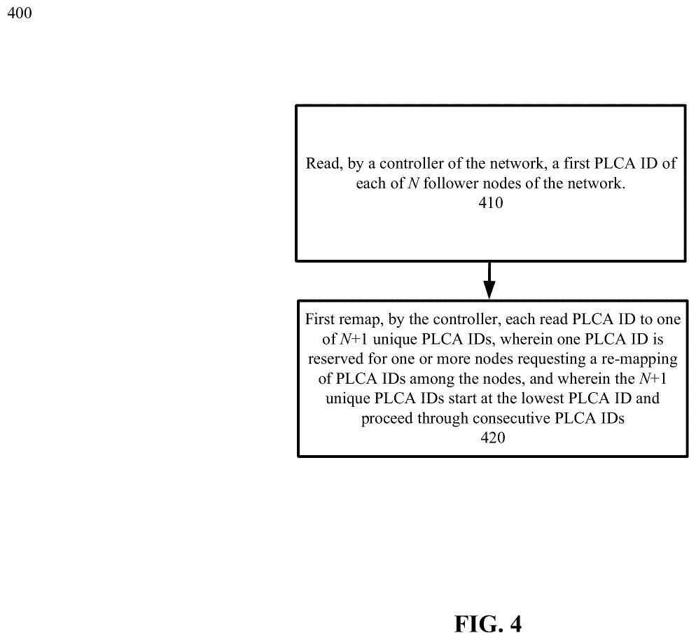

Referring to FIG. 4, and continuing to refer to prior figures for context, methods 400 of medium access control, in accordance with examples of the technology disclosed herein. In such methods 400, a controller reads a first PLCA ID of each of N follower nodes of the network—Block 410.

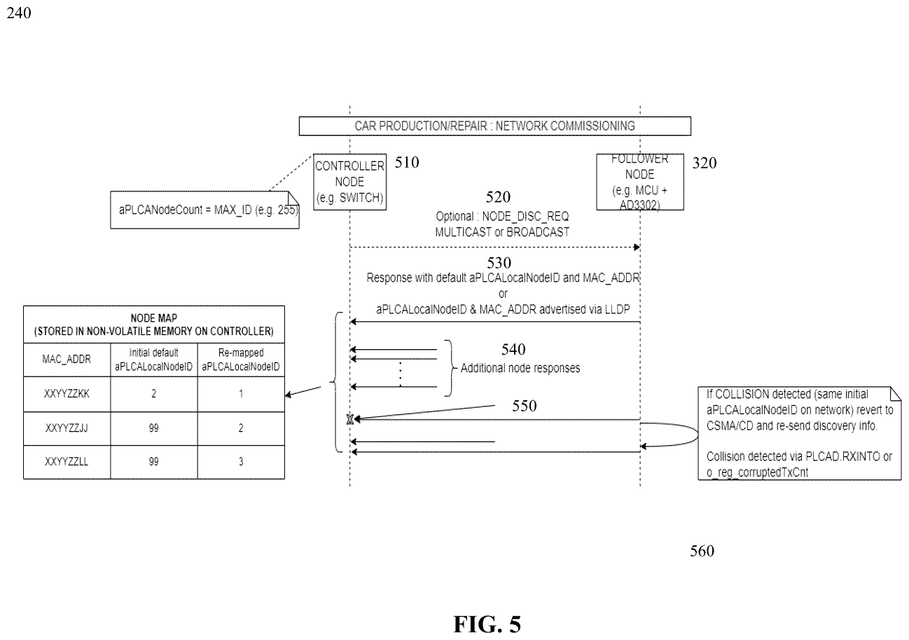

Referring to FIG. 5, and continuing to refer to prior figures for context, a network commissioning phase 240 for the continuing example is illustrated, in accordance with examples of the technology disclosed herein. In network commissioning phase 240, all follower nodes 320₁-320_{N} and the controller 510 are connected in the network—with N=3 in the example of FIG. 5. The controller 510 writes a discovery request 520, e.g., via broadcast, to each follower node 320 in the network. In the example network commissioning phase 240 there are three responding follower nodes (N=3)—i.e., MAC addresses ending in “KK,” “JJ,” and “LL.” Note that both of the problems mentioned above are present—[1] with only three nodes, the highest module ID is “99,” meaning that each PLCA cycle includes a large block of wasted TOs; and [2] two modules have a module ID of “99” and will consequently collide during the relevant TO.

If a collision occurs during the network commissioning phase 240 (e.g., two or more nodes have the same aPLCALocalNodeID from the module production phase 230), the network (controller 510 and follower nodes 320₁-320₃ can revert to CSMA/CD operation to resolve the collision and then re-send the discover request.

The controller remaps each read first PLCA ID to one of N+1 unique PLCA IDs—Block 420. One PLCA ID of the N+1 unique remapped PLCA IDs is reserved for a node requesting a subsequent re-mapping of PLCA IDs. The N+1 unique remapped PLCA IDs start at the lowest PLCA ID and proceed through consecutive PLCA IDs. In some examples, remapping includes setting the reserved PLCA ID to N+1 and setting a node count to N+2.

In the continuing example, the controller 510 maps: follower node 320₁ (MAC address “KK,” originally module ID 2) to remapped module ID 1, follower node 320₂ (MAC address “JJ,” originally duplicate module ID 99) to remapped module ID 2, and follower node 320₃ (MAC address “LL,” originally duplicate module ID 99) to remapped module ID 3. The controller 510 reserves the last module ID, module ID N+1=4, for any follower node to use to request a re-mapping. In other examples, a module ID other than the last module ID can be reserved for a follower node to use to request a re-mapping. In some examples, more than one extra module ID can be reserved—with the caveat that extra unused module IDs contribute to longer PLCA cycles.

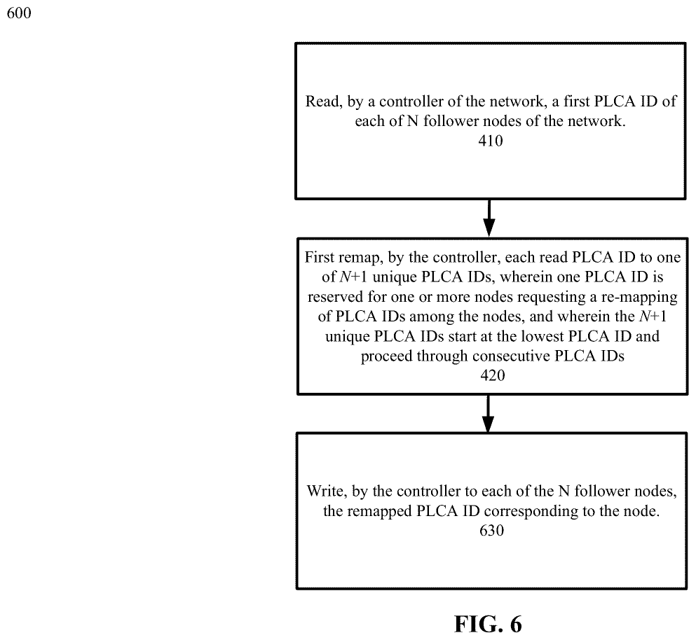

Referring to FIG. 6, and continuing to refer to prior figures for context, methods 400 of medium access control, in accordance with examples of the technology disclosed herein. In such methods 600, after the first remapping, the controller writes, to each of the N follower nodes, the remapped PLCA ID corresponding to the node—Block 610.

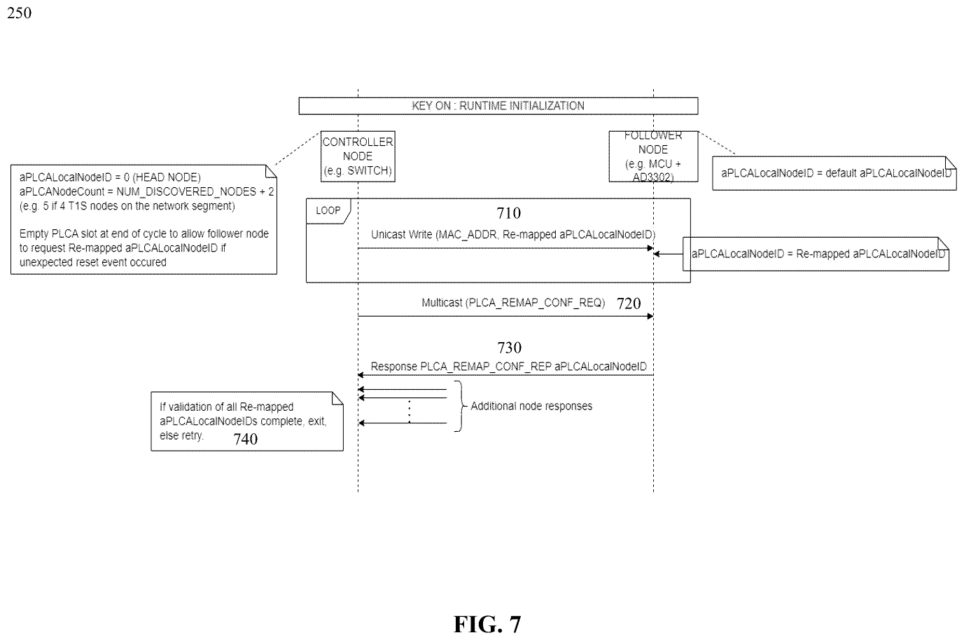

Referring to FIG. 7, and continuing to refer to prior figures for context, a runtime initialization phase 250 for the continuing example is illustrated, in accordance with examples of the technology disclosed herein. In runtime initialization phase 250, controller 510 has defined itself as node 0, and has set the total number of node to “5” (the number of discovered nodes plus two (N+2) to account for itself and the spare node ID). The controller 510 unicast writes 710 the MAC address and re-mapped node ID to each corresponding follower node 320. In the continuing example, the follower nodes do not store the re-mapped module/node IDs when the car is turned off—so the writing of Block 610 happens on each new start of the vehicle.

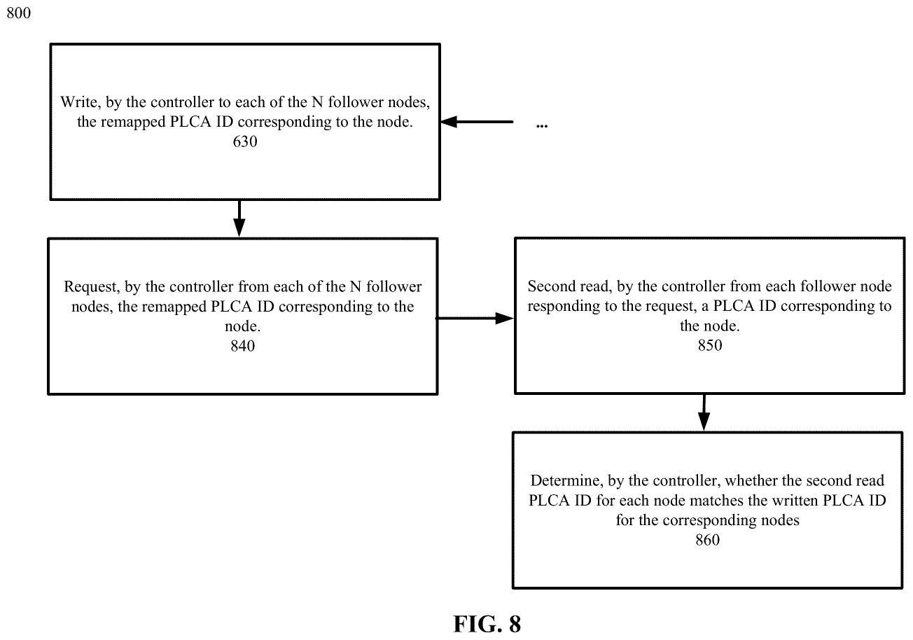

Referring to FIG. 8, and continuing to refer to prior figures for context, methods 800 of medium access control, in accordance with examples of the technology disclosed herein. In such methods 800, after the writing (Block 630), the controller requests, from each of the N follower nodes, the PLCA ID corresponding to the node—Block 840. In the example runtime initialization phase 250 of FIG. 7, the controller 510 sends multicast (to all follower nodes having a node ID in the table) a PLCA remap confirmation request, “PLCA_REMAP_CONF_REQ.”

The controller second reads, from each follower node responding to the request, a PLCA ID corresponding to the node—Block 850. In the example runtime initialization phase 250 of FIG. 7, the controller reads 740 each of the responses from the follower nodes.

The controller determines whether the second read PLCA ID for each node matches the written PLCA ID for the corresponding node—Block 860. In the example runtime initialization phase 250 of FIG. 7, the controller determines whether all node IDs have been properly remapped.

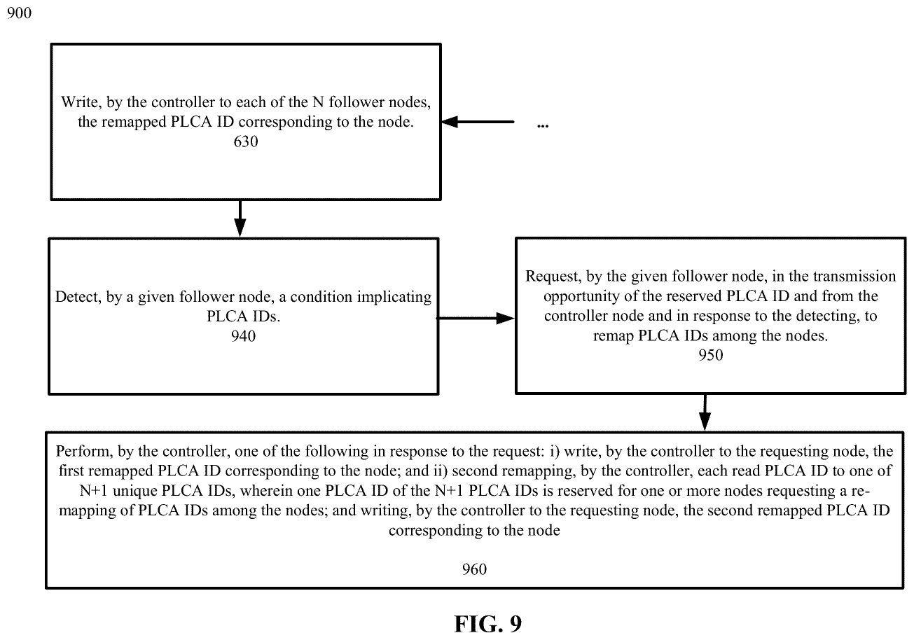

Referring to FIG. 9, and continuing to refer to prior figures for context, methods 900 of medium access control, in accordance with examples of the technology disclosed herein. In such methods 900, after the writing (Block 630), a given follower node detects a condition implicating PLCA IDs—Block 940.

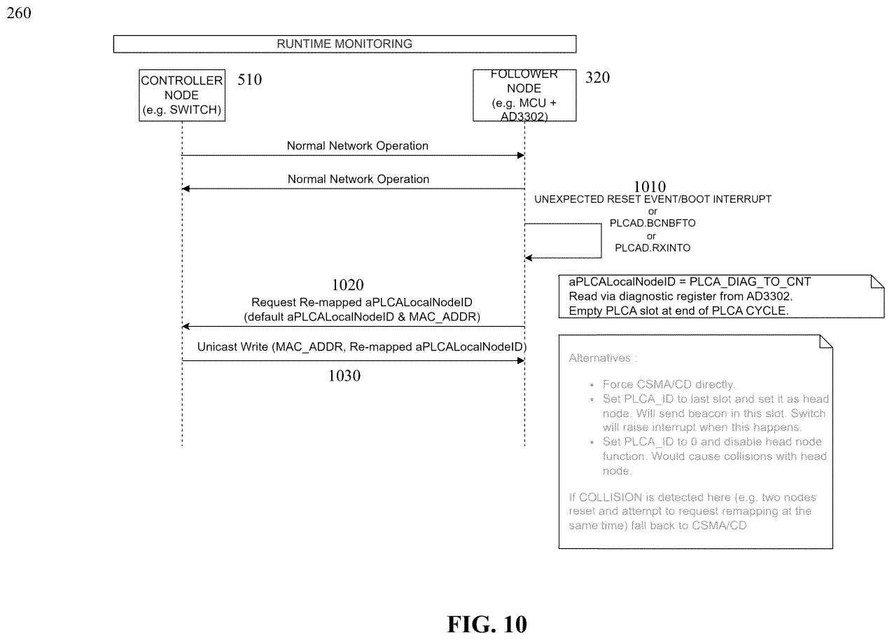

Referring to FIG. 10, and continuing to refer to prior figures for context, a runtime monitoring phase 260 for the continuing example is illustrated, in accordance with examples of the technology disclosed herein. In runtime monitoring phase 260, the controller 510 and each follower 320 communicate normal operation under 10BASE-T1S protocol. Each follower node monitors 1010 of a condition implicating the PLCA IDs. Such conditions include, but are not limited to, reset events (e.g., module removable and replacement during repair), a boot interrupt, or a PLCA diagnostic code (e.g., PLCA Diagnostics BeacoN BeFore TO “PLCAD.BCNBFTO,” PLCA Receive Into TO PLCAD.RXINTO). The follower 320 with MAC address ending in “LL” resets and returns to its module ID of “99.”

The given follower node requests, in the TO of the reserved PLCA ID and in response to the detecting, the controller node to remap PLCA IDs among the nodes—Block 950. In the continuing example, a follower 320 with MAC address ending in “LL” sets its own PLCA ID to the reserved node ID (in this case to PLCA_DIAG_TO_CNT) and requests 1020 a remapped PLCALocalNodeID and sends the controller 510 its default aPLCALocalNodeID (99) and MAC address (*LL).

The controller performs one of the following in response to the request to subsequent remap: i) writing, to the each node, the first remapped PLCA ID corresponding to the node; and ii) second remapping each read PLCA ID to one of N+1 unique PLCA IDs, wherein one PLCA ID of the N+1 PLCA IDs is reserved for one or more nodes requesting a re-mapping of PLCA IDs among the nodes; and writing, by the controller to the requesting node, the second remapped PLCA ID corresponding to the node—Block 960. In the continuing example, controller 510 makes a unicast write of the MAC address and the re-mapped aPLCALocalNodeID for the follower node 320 with the MAC address ending in “LL.”

In other examples, e.g., if the controller 510 otherwise detects additional changes to the network, the controller 510 second remaps the PLCA IDs to the follower nodes 320, in some cases redoing the node discovery process. In some examples, instead of detection of a contention condition be a follower 320, the controller 510 reads signal activity indicative of a collision between a plurality of follower nodes 320 contending for use of the reserved PLCA ID. In such cases, the controller performs Block 960 in response without the need for request from a follower node 320. In some cases, e.g., two nodes reset and attempt to request re-mapping at the same time) the network nodes will fall back to CSMA/CD, and then resume PLCA after the contention is resolved.

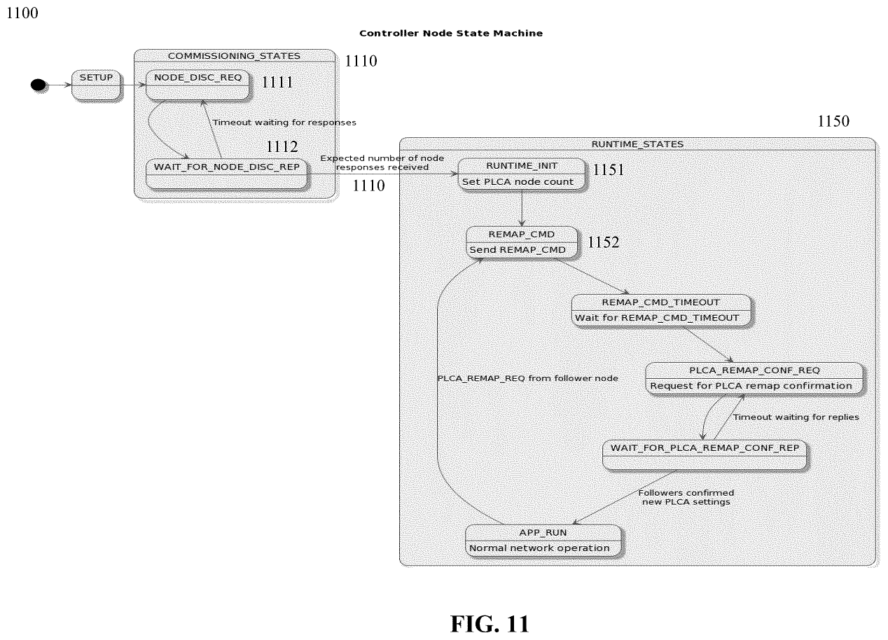

Referring to FIG. 11, and continuing to refer to prior figures for context, a state diagram 1100 for medium access control operations at a controller 510 is illustrated, in accordance with examples of the technology disclosed herein. State diagram 1100 re-iterates the commands, responses, data structures, and steps taken by the controller 510 in FIG. 5, FIG. 7, and FIG. 10.

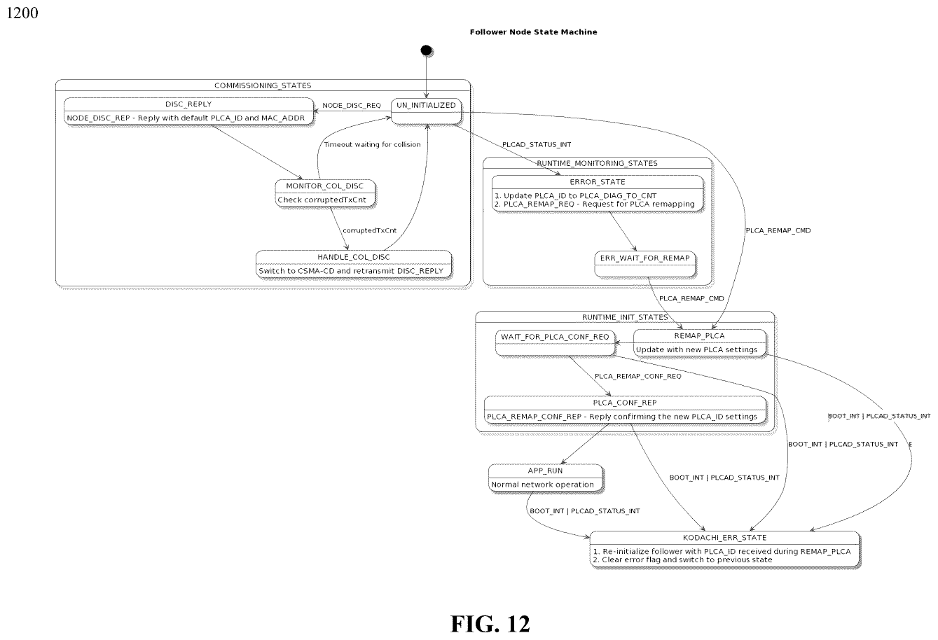

Referring to FIG. 12, and continuing to refer to prior figures for context, a state diagram 1200 for medium access control operations at a follower is illustrated, in accordance with examples of the technology disclosed herein. State diagram 1200 re-iterates the commands, responses, data structures, and steps taken by each follower 320 in FIG. 3, FIG. 4, FIG. 5, FIG. 7, and FIG. 10.

Examples of the present disclosure may be implemented into a system using any suitable hardware and/or software to configure as desired. For example, the controller node 510 logic can be implemented in a switch having an architecture; and the follower node 320 logic can be implemented in a device such as a signal light—each, in part, as described below.

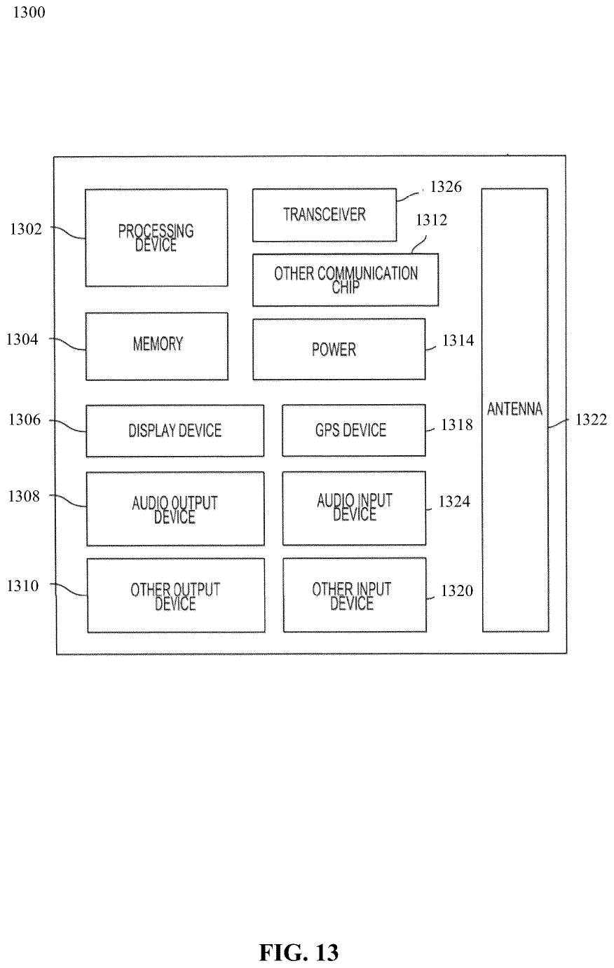

FIG. 13 schematically illustrates a device 1300 that may serve as node (e.g., a controller 510 or follower 320), in accordance with various examples. A number of components are illustrated in FIG. 13 as included in the device 1300, but any one or more of these components may be omitted or duplicated, as suitable for the application. The device 1300 and components thereof can serve as means for implementing any one or more of the features of the technology disclosed herein.

Additionally, in various examples, the device 1300 may not include one or more of the components illustrated in FIG. 13, but the device 1300 may include interface circuitry for coupling to the one or more components. For example, the device 1300 may not include a display device 1306, but may include display device interface circuitry (e.g., a connector and driver circuitry) to which a display device 1306 may be coupled. In another set of examples, the device 1300 may not include an audio input device 1324 or an audio output device 1308, but may include audio input or output device interface circuitry (e.g., connectors and supporting circuitry) to which an audio input device 1324 or audio output device 1308 may be coupled.

The device 1300 may include the node transceiver 1326 for managing communication along the network when the device 1300 is coupled to the network. The device 1300 may include a processing device 1302 (e.g., one or more processing devices), which may be included in the node transceiver 1326 or separate from the node transceiver 1326. As used herein, the term “processing device” may refer to any device or portion of a device that processes electronic data from registers and/or memory to transform that electronic data into other electronic data that may be stored in registers and/or memory.

The processing device 1302 may include one or more DSPs, ASICs, central processing units (CPUs), graphics processing units (GPUs), crypto-processors, or any other suitable processing devices, including any of the above implementing a state machine. The device 1300 may include a memory 1304, which may itself include one or more memory devices such as volatile memory (e.g., dynamic random-access memory (DRAM)), non-volatile memory (e.g., read-only memory (ROM)), flash memory, solid state memory, and/or a hard drive.

In some examples, the memory 1304 may be employed to store a working copy and a permanent copy of programming instructions to cause the device 1300 to perform any suitable ones of the techniques disclosed herein. In some examples, machine-accessible media (including non-transitory computer-readable storage media), methods, systems, and devices for performing the above-described techniques are illustrative examples disclosed herein for communication over a two-wire bus. For example, a computer-readable media (e.g., the memory 1304) may have stored thereon instructions that, when executed by one or more of the processing devices included in the processing device 1302, cause the device 1300 to perform any of the techniques disclosed herein.

In some examples, the device 1300 may include another communication chip 1312 (e.g., one or more other communication chips). For example, the communication chip 1312 may be configured for managing wireless communications for the transfer of data to and from the device 1300. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some examples they might not.

The communication chip 1312 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The one or more communication chips 1312 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The one or more communication chips 1312 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The one or more communication chips 1312 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1312 may operate in accordance with other wireless protocols in other examples. The device 1300 may include an antenna 1322 to facilitate wireless communications and/or to receive other wireless communications (such as AM or FM radio transmissions).

In some examples, the communication chip 1312 may manage wired communications using a protocol other than the protocol for the network described herein. Wired communications may include electrical, optical, or any other suitable communication protocols. Examples of wired communication protocols that may be enabled by the communication chip 1312 include Ethernet, controller area network (CAN), I2C, media-oriented systems transport (MOST), or any other suitable wired communication protocol.

As noted above, the communication chip 1312 may include multiple communication chips. For instance, a first communication chip 1312 may be dedicated to shorter-range wireless communications such as Wi-Fi or Bluetooth, and a second communication chip 1312 may be dedicated to longer-range wireless communications such as global positioning system (GPS), EDGE, GPRS, CDMA, WiMAX, LTE, EV-DO, or others. In some examples, a first communication chip 1312 may be dedicated to wireless communications, and a second communication chip 1312 may be dedicated to wired communications.

The device 1300 may include battery/power circuitry 1314. The battery/power circuitry 1314 may include one or more energy storage devices (e.g., batteries or capacitors) and/or circuitry for coupling components of the device 1300 to an energy source separate from the device 1300 (e.g., AC line power, voltage provided by a car battery, etc.). For example, the battery/power circuitry 1314 may include the upstream bus interface circuitry and the downstream bus interface circuitry discussed above with reference to FIG. 2 and could be charged by the bias on the network.

The device 1300 may include a display device 1306 (or corresponding interface circuitry, as discussed above). The display device 1306 may include any visual indicators, such as a heads-up display, a computer monitor, a projector, a touchscreen display, a liquid crystal display (LCD), a light-emitting diode display, or a flat panel display, for example.

The device 1300 may include an audio output device 1308 (or corresponding interface circuitry, as discussed above). The audio output device 1308 may include any device that generates an audible indicator, such as speakers, headsets, or earbuds, for example.

The device 1300 may include an audio input device 1324 (or corresponding interface circuitry, as discussed above). The audio input device 1324 may include any device that generates a signal representative of a sound, such as microphones, microphone arrays, or digital instruments (e.g., instruments having a musical instrument digital interface (MIDI) output).

The device 1300 may include a GPS device 1318 (or corresponding interface circuitry, as discussed above). The GPS device 1318 may be in communication with a satellite-based system and may receive a location of the device 1300, as known in the art.

The device 1300 may include another output device 1310 (or corresponding interface circuitry, as discussed above). Examples of the other output device 1310 may include an audio codec, a video codec, a printer, a wired or wireless transmitter for providing information to other devices, or an additional storage device. Additionally, any suitable ones of the peripheral devices 108 discussed herein may be included in the other output device 1310.

The device 1300 may include another input device 1320 (or corresponding interface circuitry, as discussed above). Examples of the other input device 1320 may include an accelerometer, a gyroscope, an image capture device, a keyboard, a cursor control device such as a mouse, a stylus, a touchpad, a bar code reader, a Quick Response (QR) code reader, or a radio frequency identification (RFID) reader. Additionally, any suitable ones of the sensors or peripheral devices may be included in the other input device 1320.

Any suitable ones of the display, input, output, communication, or memory devices described above with reference to the device 1300 may serve as the peripheral device 108 in the network. Alternatively or additionally, suitable ones of the display, input, output, communication, or memory devices described above with reference to the device 1300 may be included in a node.

The nodes of a network may be chosen and configured to provide audio and/or light control over the network. In some examples, the network may be configured to serve as a light control system in a vehicle or other environment, with lighting devices (e.g., strip-line light-emitting diodes (LEDs) or other LED arrangements) serving as peripheral devices in communication with nodes in the network; data may be communicated over the network to control the color, intensity, duty cycle, and/or or other parameters of the lighting devices. In some examples, the network be configured to serve as an audio control system in a vehicle or other environment, with a microphone or other device including an accelerometer that may serve as a peripheral device in communication with a node in the network; data from the accelerometer may be communicated over the network to control other peripheral devices 108 along the network. For example, large spikes in the acceleration data or other predetermined acceleration data patterns may be used to trigger the generation of a sound effect, such as a cowbell or drum hit, by a processing device coupled to a node; that sound effect may be output by a speaker coupled to the processing device and/or by a speaker coupled to another node along the network. Some examples of the network may combine any of the lighting control and/or audio control techniques disclosed herein.

Although various ones of the examples discussed above describe the network in a vehicle setting, this is simply illustrative, and the network may be implemented in any desired setting. For example, in some examples, a “suitcase” implementation of the network may include a portable housing that includes the desired components of the network; such an implementation may be particularly suitable for portable applications, such as portable karaoke or entertainment systems.

Having thus described several aspects and examples of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the examples described herein.

Those skilled in the art will recognize or be able to ascertain using no more than routine experimentation, many equivalents to the specific examples described herein. It is, therefore, to be understood that the foregoing examples are presented by way of example only and that, within the scope of the appended claims and equivalents thereto, inventive examples may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The foregoing outlines features of one or more examples of the subject matter disclosed herein. These examples are provided to enable a person having ordinary skill in the art (PHOSITA) to better understand various aspects of the present disclosure. Certain well-understood terms, as well as underlying technologies and/or standards may be referenced without being described in detail. It is anticipated that the PHOSITA will possess or have access to background knowledge or information in those technologies and standards sufficient to practice the teachings of the present disclosure.

The PHOSITA will appreciate that they may readily use the present disclosure as a basis for designing or modifying other processes, structures, or variations for carrying out the same purposes and/or achieving the same advantages of the examples introduced herein. The PHOSITA will also recognize that such equivalent constructions do not depart from the spirit and scope of the present disclosure, and that they may make various changes, substitutions, and alterations herein without departing from the spirit and scope of the present disclosure.

The above-described examples may be implemented in any of numerous ways. One or more aspects and examples of the present application involving the performance of processes or methods may utilize program instructions executable by a device (e.g., a computer, a processor, or other device) to perform, or control performance of, the processes or methods.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various examples described above.

The computer readable medium or media may be transportable, such that the program or programs stored thereon may be loaded onto one or more different computers or other processors to implement various ones of the aspects described above. In some examples, computer readable media may be non-transitory media.

Note that the activities discussed above with reference to Figures are applicable to any integrated circuit that involves signal processing (for example, gesture signal processing, video signal processing, audio signal processing, analog-to-digital conversion, digital-to-analog conversion), particularly those that can execute specialized software programs or algorithms, some of which may be associated with processing digitized real-time data.

In some cases, the teachings of the present disclosure may be encoded into one or more tangible, non-transitory computer-readable mediums having stored thereon executable instructions that, when executed, instruct a programmable device (such as a processor or DSP) to perform the methods or functions disclosed herein. In cases where the teachings herein are embodied at least partly in a hardware device (such as an ASIC, IP block, or SoC), a non-transitory medium could include a hardware device hardware-programmed with logic to perform the methods or functions disclosed herein. The teachings could also be practiced in the form of Register Transfer Level (RTL) or other hardware description language such as VHDL or Verilog, which can be used to program a fabrication process to produce the hardware elements disclosed.

In example implementations, at least some portions of the processing activities outlined herein may also be implemented in software. In some examples, one or more of these features may be implemented in hardware provided external to the elements of the disclosed figures, or consolidated in any appropriate manner to achieve the intended functionality. The various components may include software (or reciprocating software) that can coordinate in order to achieve the operations as outlined herein. In still other examples, these elements may include any suitable algorithms, hardware, software, components, modules, interfaces, or objects that facilitate the operations thereof.

Any suitably configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, an FPGA, an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, processors may store information in any suitable type of non-transitory storage medium (for example, random access memory (RAM), read only memory (ROM), FPGA, EPROM, electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe.

Any of the memory items discussed herein should be construed as being encompassed within the broad term ‘memory.’ Similarly, any of the potential processing elements, modules, and machines described herein should be construed as being encompassed within the broad term ‘microprocessor’ or ‘processor.’ Furthermore, in various examples, the processors, memories, network cards, buses, storage devices, related peripherals, and other hardware elements described herein may be realized by a processor, memory, and other related devices configured by software or firmware to emulate or virtualize the functions of those hardware elements.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a personal digital assistant (PDA), a smart phone, a mobile phone, an iPad, or any other suitable portable or fixed electronic device.

Also, a computer may have one or more input and output devices. These devices can be used, among other things, to present a user interface. Examples of output devices that may be used to provide a user interface include printers or display screens for visual presentation of output and speakers or other sound generating devices for audible presentation of output.

Examples of input devices that may be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Computer-executable instructions may be in many forms, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various examples.

The terms “program” or “software” are used herein in a generic sense to refer to any type of computer code or set of computer-executable instructions that may be employed to program a computer or other processor to implement various aspects as described above. Additionally, it should be appreciated that according to one aspect, one or more computer programs that when executed perform methods of the present application need not reside on a single computer or processor, but may be distributed in a modular fashion among a number of different computers or processors to implement various aspects of the present application.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code may be executed on any suitable processor or collection of processors, whether provided in a single computer or distributed among multiple computers.

Computer program logic implementing all or part of the functionality described herein is embodied in various forms, including, but in no way limited to, a source code form, a computer executable form, a hardware description form, and various intermediate forms (for example, mask works, or forms generated by an assembler, compiler, linker, or locator). In an example, source code includes a series of computer program instructions implemented in various programming languages, such as an object code, an assembly language, or a high-level language such as OpenCL, RTL, Verilog, VHDL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In some examples, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc.

Other components such as external storage, additional sensors, controllers for audio/video display, and peripheral devices may be attached to the board as plug-in cards, via cables, or integrated into the board itself. In another example, the electrical circuits of the FIGURES may be implemented as standalone modules (e.g., a device with associated components and circuitry configured to perform a specific application or function) or implemented as plug-in modules into application-specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this disclosure.

In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Also, as described, some aspects may be embodied as one or more methods. The acts performed as part of the method may be ordered in any suitable way. Accordingly, examples may be constructed in which acts are performed in an order different than illustrated, which may include performing some acts simultaneously, even though shown as sequential acts in illustrative examples.

### Interpretation of Terms

All definitions, as defined and used herein, should be understood to control over dictionary definitions, definitions in documents incorporated by reference, and/or ordinary meanings of the defined terms. Unless the context clearly requires otherwise, throughout the description and the claims: “comprise,” “comprising,” and the like are to be construed in an inclusive sense, as opposed to an exclusive or exhaustive sense; that is to say, in the sense of “including, but not limited to.” “Connected,” “coupled,” or any variant thereof, means any connection or coupling, either direct or indirect, between two or more elements. The coupling or connection between the elements can be physical, logical, or a combination thereof. “Herein,” “above,” “below,” and words of similar import, when used to describe this specification shall refer to this specification as a whole and not to any particular portions of this specification. “Or,” in reference to a list of two or more items, covers all of the following interpretations of the word: any of the items in the list, all of the items in the list, and any combination of the items in the list. The singular forms “a,” “an” and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined.

Elements other than those specifically identified by the “and/or” clause may optionally be present, whether related or unrelated to those elements specifically identified. Thus, as a non-limiting example, a reference to “A and/or B”, when used in conjunction with open-ended language such as “comprising” may refer, in one example, to A only (optionally including elements other than B); in another example, to B only (optionally including elements other than A); in yet another example, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

Thus, as a non-limiting example, “at least one of A and B” (or, equivalently, “at least one of A or B,” or, equivalently “at least one of A and/or B”) may refer, in one example, to at least one, optionally including more than one, A, with no B present (and optionally including elements other than B); in another example, to at least one, optionally including more than one, B, with no A present (and optionally including elements other than A); in yet another example, to at least one, optionally including more than one, A, and at least one, optionally including more than one, B (and optionally including other elements); etc.

As used herein, the term “between” is to be inclusive unless indicated otherwise. For example, “between A and B” includes A and B unless indicated otherwise.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke 35 U.S.C. § 112(f) as it exists on the date of the filing hereof unless the words “means for” or “steps for” are specifically used in the particular claims; and (b) does not intend, by any statement in the disclosure, to limit this disclosure in any way that is not otherwise reflected in the appended claims.

The present invention should therefore not be considered limited to the particular examples described above. Various modifications, equivalent processes, as well as numerous structures to which the present invention may be applicable, will be readily apparent to those skilled in the art to which the present invention is directed upon review of the present disclosure.

It should be understood that the detailed description and specific examples, while indicating examples of the systems and methods are intended for purposes of illustration only and are not intended to limit the scope. These and other features, aspects, and advantages of the systems and methods of the present invention can be better understood from the description, appended claims or aspects, and accompanying drawings. It should be understood that the Figures are merely illustrative and are not drawn to scale. It should also be understood that the same reference numerals are used throughout the figures to indicate the same or similar parts.

Other variations to the disclosed examples can be understood and effected by those skilled in the art in practicing the disclosure, from a study of the drawings, the disclosure, and the appended aspects or claims. In the aspects or claims, the word “comprising” does not exclude other elements or steps, and the indefinite article “a” or “an” does not exclude a plurality. The mere fact that certain measures are recited in mutually different dependent aspects or claims does not indicate that a combination of these measures cannot be used to advantage. Any reference signs in the claims should not be construed as limited the scope.

What is claimed is:

1. A method for managing PLCA IDs in a network, comprising:
reading, by a controller of the network, a first PLCA ID of each of N follower nodes of the network; and
first remapping, by the controller, each read first PLCA ID to one of N+1 unique remapped PLCA IDs, wherein:
one PLCA ID of the N+1 unique remapped PLCA IDs is reserved for one of the follower nodes requesting a subsequent re-mapping of PLCA IDs, and
the N+1 unique remapped PLCA IDs start at a lowest PLCA ID and proceed through consecutive PLCA IDs.

2. The method of claim 1, wherein remapping comprises:
setting the reserved PLCA ID to N+1; and
setting a node count to N+2.

3. The method of claim 2, further comprising:
writing, by the controller to each of the N follower nodes, the remapped PLCA ID corresponding to the node.

4. The method of claim 3, further comprising:
requesting, by the controller from each of the N follower nodes, the PLCA ID corresponding to the node;
second reading, by the controller from each follower node responding to the request, a PLCA ID corresponding to the node; and
determining, by the controller, whether the second read PLCA ID for each node matches a first written PLCA ID for the corresponding node.

5. The method of claim 3, further corresponding:
detecting, by a follower node, an condition implicating PLCA IDs;
requesting, by the detecting follower node, in a transmission opportunity (TO) of the reserved PLCA ID, from the controller node, and in response to the detecting, to remap PLCA IDs among the nodes; and
performing, by the controller, one of the following in response to the request to subsequent remap:
i) writing, by the controller to the requesting node, the first remapped PLCA ID corresponding to the requesting node; and
ii) second remapping, by the controller, each read PLCA ID to one of N+1 unique PLCA IDs, wherein one PLCA ID of the N+1 unique PLCA IDs is reserved for one or more nodes requesting a re-mapping of PLCA IDs among the nodes; and writing, by the controller to each follower node, the second remapped PLCA ID corresponding to the node.

6. The method of claim 3, further corresponding:
reading, by the controller node, signal activity indicative of a collision between a plurality of follower nodes contending for use of the reserved PLCA ID; and
performing, by the controller, one of the following in response to the reading:
i) writing, by the controller to each colliding follower node, the first remapped PLCA ID corresponding to the colliding follower node; and
ii) second remapping, by the controller, each read PLCA ID to one of N+1 unique PLCA IDs, wherein one PLCA ID of the N+1 unique PLCA IDs is reserved for one or more nodes requesting a re-mapping of PLCA IDs among the nodes; and writing, by the controller to each colliding follower node, the second remapped PLCA ID corresponding to the node.

7. A system comprising:
a controller node and a plurality of follower nodes, each node in communication with each other node in a packet switched network;
the controller node comprising:
one or more controller processors; and
controller memory, storing instructions that when executed by the one or more controller processors are operative to cause the controller to:
read a first PLCA ID of each of N follower nodes of the network; and
first remap each read first PLCA ID to one of N+1 unique remapped PLCA IDs, wherein:
one PLCA ID of the N+1 unique remapped PLCA IDs is reserved for one of the follower nodes requesting a subsequent re-mapping of PLCA IDs, and
the N+1 unique remapped PLCA IDs start at a lowest PLCA ID and proceed through consecutive PLCA IDs.

8. The system of claim 7, wherein remapping comprises:
setting the reserved PLCA ID to N+1; and
setting a node count to N+2.

9. The system of claim 8, wherein the controller memory further stores instructions that when executed by the one or more controller processors are operative to cause the controller to:
write, to each of the N follower nodes, the remapped PLCA ID corresponding to the node.

10. The system of claim 9, wherein the controller memory further stores instructions that when executed by the one or more controller processors are operative to cause the controller to:
request, from each of the N follower nodes, the PLCA ID corresponding to the node;
second read, from each follower node responding to the request, a PLCA ID corresponding to the node; and
determine whether the second read PLCA ID for each node matches a first written PLCA ID for the corresponding node.

11. The system of claim 9, wherein:
each follower node comprises:
one or more follower processors; and
follower memory, storing instructions that when executed by the one or more follower processors are operative to cause the follower to:
detect an condition implicating PLCA IDs;
request in a transmission opportunity (TO) of the reserved PLCA ID, from the controller node, and in response to the detecting, to remap PLCA IDs among the nodes; and
the controller memory further stores instructions that when executed by the one or more controller processors are operative to cause the controller to:
perform one of the following in response to the request to subsequent remap:
i) writing, to the requesting node, the first remapped PLCA ID corresponding to the requesting node; and
ii) second remapping each read PLCA ID to one of N+1 unique PLCA IDs, wherein one PLCA ID of the N+1 unique PLCA IDs is reserved for one or more nodes requesting a re-mapping of PLCA IDs among the nodes; and writing, by the controller to each follower node, the second remapped PLCA ID corresponding to the node.

12. The system of claim 9, wherein the controller memory further stores instructions that when executed by the one or more controller processors are operative to cause the controller to:
read signal activity indicative of a collision between a plurality of follower nodes contending for use of the reserved PLCA ID; and
perform one of the following in response to the reading:
i) writing, to each colliding follower node, the first remapped PLCA ID corresponding to the colliding follower node; and
ii) second remapping each read PLCA ID to one of N+1 unique PLCA IDs, wherein one PLCA ID of the N+1 unique PLCA IDs is reserved for one or more nodes requesting a re-mapping of PLCA IDs among the nodes; and writing, by the controller to each colliding follower node, the second remapped PLCA ID corresponding to the node.

13. A computer program product comprising computer readable media storing instructions that when executed by one or more processors of one a node of a network implementing a PLCA protocol are operative to:
read a first PLCA ID of each of N follower nodes of the network; and
first remap each read first PLCA ID to one of N+1 unique remapped PLCA IDs, wherein:
one PLCA ID of the N+1 unique remapped PLCA IDs is reserved for one of the follower nodes requesting a subsequent re-mapping of PLCA IDs, and
the N+1 unique remapped PLCA IDs start at a lowest PLCA ID and proceed through consecutive PLCA IDs.

14. The computer program product of claim 13, wherein remapping comprises:
setting the reserved PLCA ID to N+1; and
setting a node count to N+2.

15. The computer program product of claim 14, wherein the computer readable media further stores instructions that when executed by the one or more processors are operative to cause the node to:
write, to each of the N follower nodes, the remapped PLCA ID corresponding to the node.

16. The computer program product of claim 15, wherein the computer readable media further stores instructions that when executed by the one or more processors are operative to cause the node to:
request, from each of the N follower nodes, the PLCA ID corresponding to the node;
second read, from each follower node responding to the request, a PLCA ID corresponding to the node; and
determine whether the second read PLCA ID for each node matches a first written PLCA ID for the corresponding node.

17. The computer program product of claim 15, wherein the computer readable media further stores instructions that when executed by the one or more processors are operative to cause the node to:
detect, by a follower node, a condition implicating PLCA IDs;
request, by the detecting follower node, in a transmission opportunity (TO) of the reserved PLCA ID, from a controller node, and in response to the detecting, to remap PLCA IDs among the nodes; and
perform one of the following in response to the request to subsequent remap:
i) writing, to the requesting node, the first remapped PLCA ID corresponding to the requesting node; and
ii) second remapping each read PLCA ID to one of N+1 unique PLCA IDs, wherein one PLCA ID of the N+1 unique PLCA IDs is reserved for one or more nodes requesting a re-mapping of PLCA IDs among the nodes; and writing, by the controller to each follower node, the second remapped PLCA ID corresponding to the node.

18. The computer program product of claim 15, wherein the computer readable media further stores instructions that when executed by the one or more processors are operative to cause a node to:
read signal activity indicative of a collision between a plurality of follower nodes contending for use of the reserved PLCA ID; and
perform one of the following in response to the reading:
i) writing, to each colliding follower node, the first remapped PLCA ID corresponding to the colliding follower node; and
ii) second remapping each read PLCA ID to one of N+1 unique PLCA IDs, wherein one PLCA ID of the N+1 unique PLCA IDs is reserved for one or more nodes requesting a re-mapping of PLCA IDs among the nodes; and writing, by a controller node to each colliding follower node, the second remapped PLCA ID corresponding to the node.
